(19) United States
(12) Patent Application Publication
(10) Pub. No.: US 2026/0218334 A1
(43) Pub. Date: Jul. 30, 2026

(54) PRODUCTION OF MAGNESIUM

(71) Applicant: Njordur Holding ehf., Reykjavik (IS)

(72) Inventor: Stefán Ás Ingvarsson, Stanford, CA (US)

(73) Assignee: Njordur Holding ehf., Reykjavik (IS)

(21) Appl. No.: 19/459,804

(22) Filed: Jan. 26, 2026

Related U.S. Application Data
(60) Provisional application No. 63/749,934, filed on Jan. 27, 2025.

(51) Int. Cl. C22B 26/22; C01F 5/02; C01F 5/14; C25C 5/00

(52) U.S. Cl. CPC C22B 26/22; C01F 5/02; C01F 5/14; C25C 5/00

(57) ABSTRACT

The present disclosure describes a method of producing magnesium using reactors such as a Taylor-Couette reactor or a mechanically agitated reactor. The method can include combining a magnesium-containing solution and a hydroxide solution in a reaction vessel, wherein the magnesium-containing solution and the hydroxide solution are combined to form a working solution. The method can include rotating the inner cylinder at a first angular velocity to produce a laminar Couette flow, and rotating the inner cylinder at a second angular velocity, wherein the second angular velocity is greater than the first angular velocity, to produce a Taylor vortex flow, thereby precipitating magnesium from the working solution. Alternatively, the method can include generating a controlled hydrodynamic shear field, a controlled mixing regime, or a combination thereof to precipitate magnesium from the working solution.

### CROSS-REFERENCE TO RELATED APPLICATIONS

This application claims priority to U.S. Provisional Patent Application No. 63/749,934, filed on Jan. 27, 2025, which is hereby incorporated by reference herein in its entirety.

### FIELD

The present disclosure relates generally to methods of producing magnesium. More specifically, the present disclosure relates to energy-efficient methods of producing magnesium using a Taylor-Couette reactor system.

### BACKGROUND

Magnesium is a lightweight metal with numerous industrial and commercial applications, including in automotive, aerospace, electronics, and construction industries. Its low density, high strength-to-weight ratio, and excellent castability make it an attractive material for various products. However, the production of magnesium has traditionally been energy-intensive and associated with significant environmental impacts.

The extraction of magnesium from seawater has been a known process for decades, offering a potentially abundant source of this valuable metal. Seawater contains approximately 0.13% magnesium by weight, making it a vast reservoir of this element. However, conventional methods for extracting magnesium from seawater have been complex, energy-intensive, and often economically prohibitive.

Historically, the most common method for producing magnesium from seawater involved multiple steps, including the precipitation of salts containing magnesium hydroxide, its conversion to magnesium chloride, and subsequent electrolysis or thermal reduction. This process typically requires high temperatures, often exceeding 1000° C., and results in significant carbon dioxide emissions and waste generation.

The high energy requirements and environmental concerns associated with traditional magnesium production methods have limited the widespread adoption of seawater-based extraction. As a result, alternative production methods, such as the Pidgeon process, which involves the thermal reduction of dolomite, have become prevalent, particularly in regions with access to low-cost energy sources. However, these methods also face challenges related to energy consumption and environmental impact.

In recent years, there has been growing interest in developing more efficient and environmentally friendly processes for magnesium production. Researchers and industry professionals have explored various approaches to improve the extraction of magnesium from seawater, aiming to reduce energy consumption, minimize waste generation, and enhance overall process efficiency.

As global demand for magnesium continues to grow, driven by its diverse applications and the push for lightweight materials in transportation and other sectors, there is an increasing need for innovative production methods. There remains a need for new approaches which must balance economic viability with environmental sustainability to meet demand for magnesium production.

### SUMMARY

In some aspects, the techniques described herein relate to a method of producing magnesium, including: combining a magnesium-containing solution and a hydroxide solution in a reaction vessel, the reaction vessel including: an outer cylinder, and an inner cylinder within the outer cylinder and separated from the outer cylinder by a gap, wherein the magnesium-containing solution and the hydroxide solution are combined within the gap to form a working solution, rotating the inner cylinder at a first angular velocity to produce a laminar Couette flow, and rotating the inner cylinder at a second angular velocity, wherein the second angular velocity is greater than the first angular velocity, to produce a Taylor vortex flow, thereby precipitating magnesium from the working solution.

In some aspects, the techniques described herein relate to a method, wherein the magnesium-containing solution includes seawater.

In some aspects, the techniques described herein relate to a method, wherein the hydroxide solution includes sodium hydroxide, lithium hydroxide, potassium hydroxide, calcium hydroxide, or combinations thereof.

In some aspects, the techniques described herein relate to a method, wherein the hydroxide solution has a concentration of about 0.05 M to about 5 M.

In some aspects, the techniques described herein relate to a method, wherein the first angular velocity and the second angular velocity are defined by: wherein @ is angular velocity, Rei is a Reynolds number of the inner cylinder, Ri is a radius of the inner cylinder, u is a dynamic viscosity of the working solution, p is a density of the working solution, and d is a width of the gap.

In some aspects, the techniques described herein relate to a method, wherein the laminar Couette flow, the Taylor vortex flow, or a combination thereof has a stability characterized by a Taylor number (Ta).

In some aspects, the techniques described herein relate to a method, wherein the Taylor number (Ta) is defined by: wherein ω is angular velocity, Ri is a radius of the inner cylinder, dis a width of the gap, and v is a kinematic viscosity of the working solution.

In some aspects, the techniques described herein relate to a method, wherein the Taylor number of the Taylor vortex flow is greater than the Taylor number of the laminar Couette flow.

In some aspects, the techniques described herein relate to a method, wherein the magnesium has a purity of greater than or equal to about 50% as measured by mass spectrometry, elemental analysis, or a combination thereof.

In some aspects, the techniques described herein relate to a method, wherein the magnesium has a purity of greater than or equal to about 75% as measured by mass spectrometry, elemental analysis, or a combination thereof.

In some aspects, the techniques described herein relate to a method, wherein the magnesium has a purity of greater than or equal to about 95% as measured by mass spectrometry, elemental analysis, or a combination thereof.

In some aspects, the techniques described herein relate to a method, further including separating the magnesium.

In some aspects, the techniques described herein relate to a method, wherein separating the magnesium includes dewatering the magnesium from the working solution.

In some aspects, the techniques described herein relate to a method, further including precipitating calcium, lithium, vanadium, or combinations thereof from the working solution.

In some aspects, the techniques described herein relate to a method, further including combining additional magnesium-containing solution and additional hydroxide solution to produce magnesium continuously.

In some aspects, the techniques described herein relate to a method, wherein the method does not produce carbon dioxide.

In some aspects, the techniques described herein relate to a method, wherein the magnesium is precipitated from the working solution in the form of magnesium hydroxide.

In some aspects, the techniques described herein relate to a method, further including reducing the magnesium hydroxide to magnesium oxide.

In some aspects, the techniques described herein relate to a method, further including reducing the magnesium hydroxide to elemental magnesium.

In some aspects, the techniques described herein relate to a method, wherein reducing the magnesium hydroxide to elemental magnesium includes converting the magnesium hydroxide to magnesium chloride, subjecting the magnesium chloride to electrolysis to produce elemental magnesium, and collecting the elemental magnesium.

In some aspects, the techniques described herein relate to a method, wherein reducing the magnesium hydroxide to elemental magnesium includes: dewatering the magnesium hydroxide from the working solution to yield a magnesium hydroxide cake; combining the magnesium hydroxide cake with aqueous hydrochloric acid to yield a magnesium chloride solution; drying the magnesium chloride solution to yield magnesium chloride; subjecting the magnesium chloride to an electrolysis process to yield elemental magnesium; and collecting the elemental magnesium by vacuum.

In some aspects, the techniques described herein relate to a method of producing magnesium, including: combining a magnesium-containing solution and a hydroxide solution in a reaction vessel, the reaction vessel including: an outer cylinder, and an inner cylinder within the outer cylinder and separated from the outer cylinder by a gap, wherein the magnesium-containing solution and the hydroxide solution are combined within the gap to form a working solution; rotating the inner cylinder at a first angular velocity to produce a laminar Couette flow; rotating the inner cylinder at a second angular velocity, wherein the second angular velocity is greater than the first angular velocity, to produce a Taylor vortex flow; thereby precipitating magnesium hydroxide from the working solution; dewatering the magnesium hydroxide from the working solution to yield a magnesium hydroxide cake; combining the magnesium hydroxide cake with aqueous hydrochloric acid to yield a magnesium chloride solution; drying the magnesium chloride solution to yield solid magnesium chloride; subjecting the solid magnesium chloride to an electrolysis process to yield elemental magnesium; and collecting the elemental magnesium.

In some aspects, the techniques described herein relate to a method of producing magnesium, including: combining a magnesium-containing solution and a hydroxide solution in a reaction vessel, wherein the magnesium-containing solution and the hydroxide solution are combined to form a working solution, wherein the reaction vessel generates a controlled hydrodynamic shear field, a controlled mixing regime, or a combination thereof, thereby precipitating magnesium from the working solution.

In some aspects, the techniques described herein relate to a method, wherein the reaction vessel includes a Taylor-Couette reactor, a mechanically agitated reactor, a rotating cylinder system, a baffled stirred tank, a static mixer, an oscillatory flow reactor, or a vortex-inducing reactor.

In some aspects, the techniques described herein relate to a method, wherein the reaction vessel includes one or more impellers.

In some aspects, the techniques described herein relate to a method, including rotating the one or more impellers at a rotational speed of about 100 rpm to about 2000 rpm.

In some aspects, the techniques described herein relate to a method, wherein the magnesium-containing solution includes seawater.

In some aspects, the techniques described herein relate to a method, wherein the hydroxide solution includes sodium hydroxide, lithium hydroxide, potassium hydroxide, calcium hydroxide, or combinations thereof.

In some aspects, the techniques described herein relate to a method, wherein the hydroxide solution has a concentration of about 0.05 M to about 5 M.

In some aspects, the techniques described herein relate to a method, further including separating the magnesium.

In some aspects, the techniques described herein relate to a method, wherein separating the magnesium includes dewatering the magnesium from the working solution.

In some aspects, there is provided a method of producing magnesium, including: combining a magnesium-containing solution and a hydroxide solution in a reaction vessel, wherein the magnesium-containing solution and the hydroxide solution are combined to form a working solution, wherein the reaction vessel generates a controlled hydrodynamic shear field, a controlled mixing regime, or a combination thereof, thereby precipitating magnesium from the working solution.

In some aspects, the techniques described herein relate to a method, wherein the reaction vessel includes a Taylor-Couette reactor, a mechanically agitated reactor, a rotating cylinder system, a baffled stirred tank, a static mixer, an oscillatory flow reactor, or a vortex-inducing reactor.

In some aspects, the techniques described herein relate to a method, wherein the reaction vessel includes one or more impellers.

In some aspects, the techniques described herein relate to a method, including rotating the one or more impellers at a rotational speed of about 100 rpm to about 2000 rpm.

In some aspects, the techniques described herein relate to a method, wherein the magnesium-containing solution includes seawater.

In some aspects, the techniques described herein relate to a method, wherein the hydroxide solution includes sodium hydroxide, lithium hydroxide, potassium hydroxide, calcium hydroxide, or combinations thereof.

In some aspects, the techniques described herein relate to a method, wherein the hydroxide solution has a concentration of about 0.05 M to about 5 M.

In some aspects, the techniques described herein relate to a method, further including separating the magnesium.

In some aspects, the techniques described herein relate to a method, wherein separating the magnesium includes dewatering the magnesium from the working solution.

### DRAWINGS

Aspects, features, benefits, and advantages of the embodiments described herein will be apparent with regard to the following description, appended claims, and accompanying drawings where:

FIG. 1 is a diagram of a reaction vessel which may be used to produce magnesium, according to an embodiment of the present disclosure.

FIG. 2 is a diagram of an electrolysis cell which may be used to reduce magnesium hydroxide to elemental magnesium, according to an embodiment of the present disclosure.

FIG. 3 is a flow chart of a method of making magnesium, according to an embodiment of the present disclosure.

FIG. 4 is a flow chart of a method of making magnesium, according to an embodiment of the present disclosure

### DETAILED DESCRIPTION

According to embodiments of the present disclosure, there is provided a method of producing magnesium from a magnesium-containing solution, such as seawater, and a hydroxide solution in a reaction vessel using Taylor-Couette flow.

Before describing the embodiments in detail, the following definitions are used throughout the present disclosure.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

As used herein, the term “about” means plus or minus 10% of the numerical value of the number with which it is being used. For example, “about 50%” means in the range of 45-55% and also includes exactly 50%. Stated differently, where any value is described herein as modified by the term “about”, the exact value is also disclosed.

As used herein, the term “purity” refers to chemical purity. The identity or identities of the chemical impurities which may be included is not limited. Chemical impurities may be identified and quantified by any method or technique available to those skilled in the art. Chemical impurities may be identified, reduced, or removed by methods available and familiar to those skilled in the art. In some embodiments, the chemical purity of the compounds described herein may be determined by an analytical method, including but not limited to high performance liquid chromatography (HPLC), mass spectrometry (MS) including inductively coupled plasma mass spectrometry (ICP-MS), or elemental analysis (EA). Other analytical techniques including but not limited to X-ray diffraction (XRD) may be used to evaluate the compounds produced by the methods of the present disclosure.

In embodiments, there is provided a method of producing magnesium which may include combining a magnesium-containing solution and a hydroxide solution in a reaction vessel. The method may include combining the magnesium-containing solution and the hydroxide solution to form a working solution. In embodiments, the reaction vessel may generate a controlled hydrodynamic shear field, a controlled mixing regime, or a combination thereof, thereby precipitating magnesium from the working solution. In embodiments, the reaction vessel includes a Taylor-Couette reactor, a mechanically agitated reactor, a rotating cylinder system, a baffled stirred tank, a static mixer, an oscillatory flow reactor, or a vortex-inducing reactor.

The reaction vessel may, in embodiments, include an outer cylinder, and an inner cylinder within the outer cylinder and separated from the outer cylinder by a gap. The magnesium-containing solution and the hydroxide solution may be combined within the gap to form a working solution. In embodiments, the method then includes rotating the inner cylinder at a first angular velocity to produce a laminar Couette flow, and rotating the inner cylinder at a second angular velocity, wherein the second angular velocity is greater than the first angular velocity, to produce a Taylor vortex flow, thereby precipitating magnesium from the working solution.

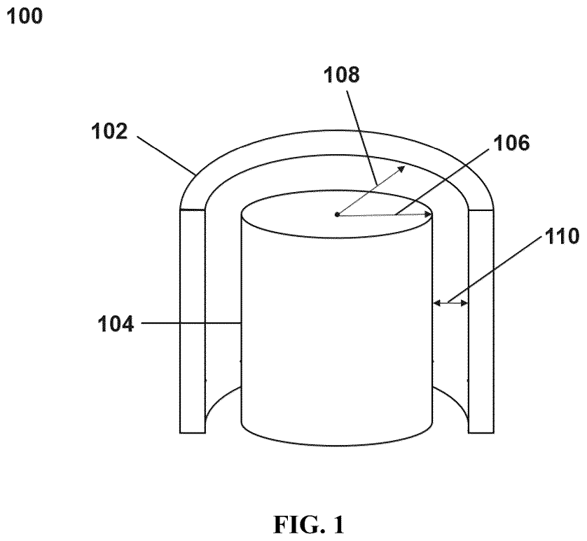

FIG. 1 is a diagram of a reaction vessel which may be used to produce magnesium, according to an embodiment of the present disclosure. As shown in FIG. 1, the reaction vessel 100 can include an outer cylinder 102 and an inner cylinder 104. The inner cylinder may have a radius 106 and the outer cylinder may have a radius 108. The inner cylinder 102 and the outer cylinder 104 may be separated by a gap 110.

In embodiments, the magnesium-containing solution can include seawater. Magnesium can be found in seawater in amounts of about 1200 ppm to about 1400 ppm. Other magnesium-containing solutions may be used as appropriate.

In embodiments, the hydroxide solution can include sodium hydroxide, lithium hydroxide, potassium hydroxide, calcium hydroxide, or combinations thereof. In embodiments, the magnesium-containing solution can include seawater and the hydroxide solution can include sodium hydroxide. The hydroxide solution can be an aqueous hydroxide solution, wherein the hydroxide is at least partially dissolved in water.

In embodiments, the hydroxide solution includes calcium hydroxide. Calcium hydroxide may be supplied as a slurry, suspension, pre-dissolved solution, or an in situ generated hydroxide stream, and may be introduced into the working solution using a feed mechanism suitable for particulate or partially dissolved alkaline media.

When calcium hydroxide is used as the hydroxide reagent, the hydroxide stream may be supplied as a saturated slurry or suspension rather than as a fully dissolved solution, in view of the lower solubility of Ca(OH)₂ in water. The solids content, particle size distribution, and slurry concentration may be adjusted depending on the desired rate of hydroxide availability and the hydrodynamic characteristics of the reaction vessel. Due to its lower solubility relative to sodium hydroxide, calcium hydroxide may provide a more controlled release of hydroxide ions, which can be beneficial for regulating local supersaturation, improving magnesium hydroxide particle morphology, reducing reagent consumption, or enhancing precipitation kinetics. Any of the reactor configurations described herein may employ calcium hydroxide under equivalent hydrodynamic conditions as those used for sodium hydroxide.

In embodiments, the hydroxide solution can have a concentration of about 0.05 M to about 5 M, such as about 0.05 M, about 0.1 M, about 0.2 M, about 0.3 M, about 0.4 M, about 0.5 M, about 1 M, about 1.5 M, about 2 M, about 2.5 M, about 3 M, about 3.5 M, about 4 M, about 5 M, or any value contained within a range formed by any two of the preceding values.

In embodiments, the first angular velocity and the second angular velocity can be selected based on the viscosity of the working solution. The first angular velocity and the second angular velocity may be defined by Equation (1):

$$ω = \frac{R {e}_{i} \cdot μ}{ρ \cdot {R}_{i} \cdot d} \qquad ( 1 )$$

In embodiments, @ is angular velocity, Reᵢ is a Reynolds number of the inner cylinder, Rᵢ is a radius of the inner cylinder, μ is a dynamic viscosity of the working solution, ρ is a density of the working solution, and dis a width of the gap. The Reynolds number is a dimensionless value that describes fluid flow patterns, relating to the ratio between inertial and viscous forces. The equation above provides the angular velocity required to achieve Taylor vortex flow as a function of the dynamic viscosity and the density of the working solution.

In embodiments, the laminar Couette flow, the Taylor vortex flow, or a combination thereof has a stability characterized by a Taylor number (Tₐ). The Taylor number can depend on factors such as rotational speed, the dimensions of the inner and outer cylinders, and the properties of the working solution. The Taylor number may be defined by Equation (2):

$${T}_{a} = \frac{ω \cdot {R}_{i} \cdot d}{v} \qquad ( 2 )$$

In embodiments, w is angular velocity, Rᵢ is a radius of the inner cylinder, dis a width of the gap, and v is a kinematic viscosity of the working solution. As the Taylor number increases, the working solution may transition through various flow regimes. In embodiments, the working solution begins in a laminar Couette flow regime at relatively low Tₐ values and then transitions to Taylor vortex flow at higher Tₐ values. In embodiments, the working solution may enter wavy vortex flow, modulated wavy vortex flow, or turbulent flow at increasing Tₐ values. The method of the present disclosure may be carried out in such a way to maintain the working solution in laminar Couette or Taylor vortex flow regimes. In embodiments, the Taylor number of the Taylor vortex flow is greater than the Taylor number of the laminar Couette flow.

In embodiments, the angular velocity ω is set based upon the critical Reynolds number appropriate for the onset of Taylor vortices, which allows the present method to achieve efficient production of magnesium. The critical Reynolds number for this process can be, in embodiments, about 40 to about 45, such as about 40.0, about 40.1, about 40.2, about 40.3, about 40.4, about 40.5, about 40.6, about 40.7, about 40.8, about 40.9, about 41.0, about 41.1, about 41.2, about 41.3, about 41.4, about 41.5, about 41.6, about 41.7, about 41.8, about 41.9, about 42.0, about 42.1, about 42.2, about 42.3, about 42.4, about 42.5, about 42.6, about 42.7, about 42.8, about 42.9, about 43.0, about 43.1, about 43.2, about 43.3, about 43.4, about 43.5, about 43.6, about 43.7, about 43.8, about 43.9, about 44.0, about 44.1, about 44.2, about 44.3, about 44.4, about 44.5, about 44.6, about 44.7, about 44.8, about 44.9, about 45.0, or any value contained within a range formed by any two of the preceding values. In embodiments, the critical Reynolds number for the onset of Taylor vortices is about 41.3.

In embodiments, the critical Reynolds number for the onset of Taylor vortices in a Taylor-Couette reactor is derived from linear stability theory which is applied to the flow between concentric cylinders. The angular velocities in a Taylor-Couette reactor are influenced by the physical and chemical processes being implemented therein. The stability and transition between different flow regimes are related to the Reynolds numbers associated with the rotating inner and outer cylinders. If both cylinders are stationary or moving at too low an angular velocity, the flow remains quiescent or in only the laminar Couette flow regimes. At high angular velocities, the flow transitions to turbulence which is characterized by chaotic motion and significant energy dissipation, which is typically undesirable, particularly when precise mixing and flow patterns such as Taylor vortices are required.

Taylor vortices form at a critical angular velocity ratio between the inner and outer cylinders, which may be described by the Taylor number. This relationship is demonstrated in Equation (3):

$${T}_{a} = \frac{{( {R}_{o} - {R}_{i} )}^{2} {( {ω}_{i} {R}_{i} - {ω}_{o} {R}_{o} )}^{2}}{{v}^{2}} \qquad ( 3 )$$

In embodiments, Rₒ is the radius of the outer cylinder, Rᵢ is the radius of the inner cylinder, ωᵢ is the angular velocity of the inner cylinder, ωₒ is the angular velocity of the outer cylinder, and v is the kinematic viscosity of the working solution. Equation (3) may be simplified to Equation (2) above in embodiments wherein the outer cylinder is held stationary and only the inner cylinder is rotated. Higher Tₐ values indicate a transition to more complex flow regimes, which may be undesirable beyond Taylor vortex flow.

The critical Reynolds number value is approximate and specifically applies to Newtonian fluids in a Taylor-Couette system where the following conditions are met: a stationary outer cylinder (ωₒ=0), a moderate gap ratio (Rₒ/Rᵢ=~1.1), and negligible end effects (assuming an infinitely long cylinder). When these conditions are met, the critical Reynolds number is primarily determined by the geometry of the system. However, the angular velocity required to achieve the critical Reynolds number depends on the properties of the fluid, in this case the working solution, and in particular, the dynamic viscosity and density. The dynamic viscosity of the fluid affects how quickly the flow transitions from stable to unstable. Dynamic viscosity (μ) and density (ρ) determine the kinematic viscosity (v), as shown in Equation (4):

$$v = \frac{μ}{ρ} \qquad ( 4 )$$

Variables such as gap ratio, cylinder height, and outer cylinder rotation can affect the critical Reynolds number associated with the onset of Taylor vortices. For example, a larger gap ratio (Rₒ/Rᵢ) may increase the critical Reynolds number. Rotating both the inner and outer cylinders in the same direction may also increase critical Reynolds number. Rotating the inner and outer cylinders in opposite directions may decrease the critical Reynolds number.

In embodiments, the methods described herein may be implemented using alternative reactor configurations that provide controlled mixing, shear, vortical flow, or combinations thereof necessary for inducing magnesium hydroxide precipitation. These configurations may include mechanically stirred tanks, impeller-driven mixing vessels, static-mixer tubular reactors, or oscillatory flow reactors. Such reactors are capable of producing hydrodynamic environments functionally comparable to Taylor vortex flow, such as a controlled hydrodynamic shear field, a controlled mixing regime, or a combination thereof.

It was discovered during the present work that controlled hydrodynamic shear mixing within a defined flow regime significantly enhances the precipitation kinetics, particle size distribution, and purity of magnesium hydroxide. While Taylor-Couette flow offers one implementation of such controlled hydrodynamics and provide a well-controlled method for generating shear-driven vortex structures, other types of reactors may be used to generate comparable shear profiles, mixing zones, or vortical structures. Such other reactor geometries include baffled stirred tanks, mechanically agitated reactors, static mixers, oscillatory flow reactors, and vortex-inducing reactors. These alternative configurations may achieve equivalent or comparable precipitation efficiency by generating shear rates or mixing intensities overlapping with those observed in Taylor vortex flow. The underlying principle of the present work is the induction of defined shear fields and micro-mixing environments that promote rapid and complete magnesium precipitation while minimizing dissolution or reversion.

In embodiments wherein the magnesium-containing solution includes seawater, the seawater may be used for other purposes or returned to the sea after the present method. The composition and properties of the seawater are contemplated to remain largely unchanged, other than a reduction in magnesium content.

The method may further include precipitating calcium, lithium, vanadium, or combinations thereof from the working solution. These compounds may be isolated and used as appropriate.

In embodiments, the method further includes combining additional magnesium-containing solution and additional hydroxide solution to produce magnesium continuously. The method may require relatively low energy, avoiding the need for high temperatures required by other methods of producing magnesium. In embodiments, the present method does not produce carbon dioxide as a byproduct, making the present method more environmentally friendly than other methods of producing magnesium.

In embodiments, the method further includes separating the magnesium. In embodiments, the magnesium produced by the present method is precipitated from the working solution in the form of magnesium hydroxide. The magnesium hydroxide may precipitate and accumulate within the reaction vessel. The magnesium hydroxide may be extracted from the reaction vessel as a slurry containing water.

In embodiments, separating the magnesium can include dewatering the magnesium from the working solution. Dewatering the magnesium can include various separation or filtration techniques including but not limited to pressure filtration and centrifugation. In embodiments, separating the magnesium can include removing the magnesium hydroxide from the reaction vessel and centrifuging the magnesium hydroxide slurry for the purpose of washing and dewatering. Centrifuging or otherwise dewatering the magnesium hydroxide slurry can yield a magnesium hydroxide cake, which may be a solid. The magnesium hydroxide cake may be washed to remove residual seawater which may include undesirable dissolved salts.

In embodiments, the method can further include reducing the magnesium hydroxide to magnesium oxide. The magnesium oxide may be collected and used as appropriate.

In embodiments, the method can further include reducing the magnesium hydroxide to elemental magnesium. Reducing the magnesium hydroxide to elemental magnesium can include converting the magnesium hydroxide to magnesium chloride, subjecting the magnesium chloride to electrolysis to produce elemental magnesium, and collecting the elemental magnesium.

For example, the magnesium hydroxide cake can be dissolved in aqueous hydrochloric acid to yield a magnesium chloride solution. The magnesium chloride solution may be transferred to an evaporator to remove excess water. In embodiments, the distillate collected from the evaporator (that is, the water that is evaporated from magnesium chloride solution) can be used as appropriate. In embodiments, the distillate collected from evaporation of magnesium chloride can be used as a source of demineralized water at a facility wherein magnesium is produced by the method disclosed herein.

The remaining magnesium chloride salt that remains after evaporation may contain residual seawater salts and may further include magnesium chloride hexahydrate. In embodiments, the magnesium chloride may be fed into a crystallizer to produce a crystalline form of magnesium chloride, which may include or be in the form of magnesium chloride hexahydrate. The magnesium chloride may be dried to remove any remaining water and to yield anhydrous magnesium chloride, which may be in a crystalline form. In embodiments, the magnesium chloride (which may include or be in the form of magnesium chloride hexahydrate) may be dried in a fluidized bed dryer to remove residual or bound water.

In embodiments, the residual seawater salts may be removed as a waste solution, and may be disposed of, otherwise used, or discharged into the sea, as appropriate.

In embodiments, the dried magnesium chloride may be subjected to electrolysis to produce magnesium. Subjecting the magnesium chloride to electrolysis can include transferring the magnesium chloride to an electrolysis cell which may include a refractory lined vessel containing two compartments, such as an electrolysis compartment and a metal-separating compartment. The two compartments can be divided by a partition that allows molten magnesium and electrolyte to flow through. The electrolyte may include magnesium chloride, calcium chloride, sodium chloride, potassium chloride, or combinations thereof. The electrolysis compartment can, in embodiments, include graphite anodes and steel cathodes, which can be used to conduct electricity into a molten bath.

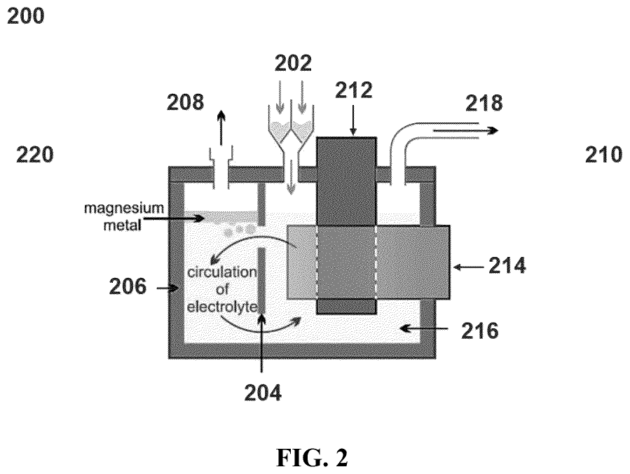

FIG. 2 is a diagram of an electrolysis cell which may be used to reduce magnesium hydroxide to elemental magnesium, according to an embodiment of the present disclosure. As shown in FIG. 2, the magnesium chloride may enter the electrolysis system 200 through an inlet 202. The electrolysis system may include an electrolysis compartment 210 and a metal-separating compartment 220. The electrolysis compartment 210 can include an anode 212, a cathode 214, an electrolyte 216, and an outlet 218 for removal of chlorine gas. The electrolysis cell 200 may further include a partition 204, a refractory lining 206, and an outlet 208 through which elemental magnesium may be removed.

In embodiments, the magnesium chloride may be added to the electrolysis compartment wherein it is converted to elemental magnesium. The elemental magnesium may diffuse through the partition and collect in the metal-separating compartment. In embodiments, chlorine gas may be formed as a byproduct of the reduction of magnesium chloride to elemental magnesium, and the chlorine gas may be discharged from the electrolysis cell and collected or safely disposed of.

The elemental magnesium may be removed from the metal-separating compartment. In embodiments, the elemental magnesium may be removed from the metal-separating compartment using vacuum. After removal from the metal-separating compartment, the elemental magnesium may be transferred to a holding furnace as molten magnesium. Impurities, including oxides, dross, and the like, may be removed. The molten magnesium may be cast and solidified into ingots.

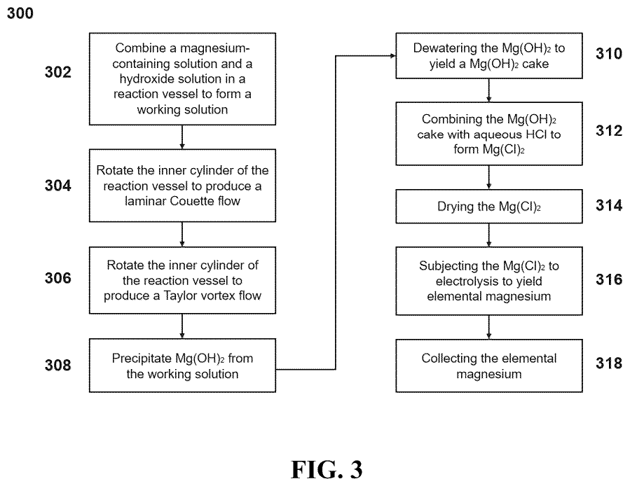

FIG. 3 is a flow chart of a method of making magnesium, according to an embodiment of the present disclosure. In embodiments, the method of producing magnesium 300 can include combining a magnesium-containing solution and a hydroxide solution in a reaction vessel 302, wherein the reaction vessel includes an outer cylinder, and an inner cylinder within the outer cylinder and separated from the outer cylinder by a gap, wherein the magnesium-containing solution and the hydroxide solution are combined within the gap to form a working solution. The method can include rotating the inner cylinder at a first angular velocity 304 to produce a laminar Couette flow, and rotating the inner cylinder at a second angular velocity 306, wherein the second angular velocity is greater than the first angular velocity, to produce a Taylor vortex flow, thereby precipitating magnesium hydroxide from the working solution 308. The method can further include dewatering the magnesium hydroxide from the working solution to yield a magnesium hydroxide cake 310; combining the magnesium hydroxide cake with aqueous hydrochloric acid to yield a magnesium chloride solution 312; drying the magnesium chloride solution to yield solid magnesium chloride 314; subjecting the solid magnesium chloride to an electrolysis process to yield elemental magnesium 316; and collecting the elemental magnesium 318.

In embodiments, step of combining a magnesium-containing solution and a hydroxide solution in a reaction vessel 302 can occur in a Taylor-Couette reactor. In another embodiment, the magnesium-containing solution and hydroxide solution may be combined in a mechanically agitated vessel, such as a continuous stirred-tank reactor (CSTR). The vessel may contain one or more impellers selected from Rushton turbines, pitched-blade turbines, hydrofoil impellers, marine propellers, or combinations thereof.

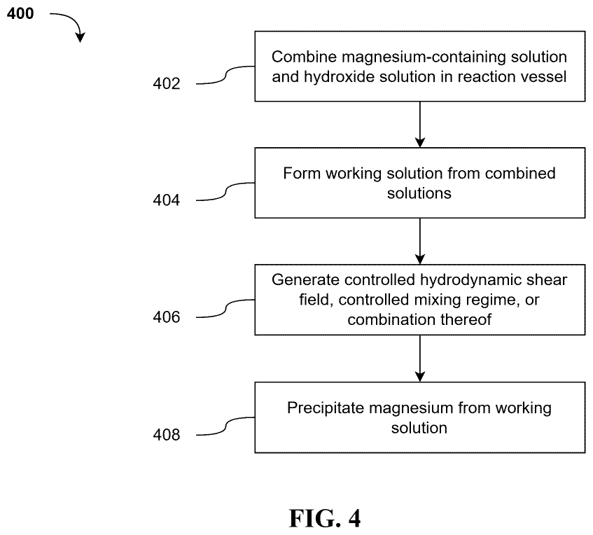

FIG. 4 is a flow chart of a method of making magnesium, according to an embodiment of the present disclosure. The method 400 includes a step 402, wherein a magnesium-containing solution and a hydroxide solution are combined in a reaction vessel. The method 400 includes a step 404, wherein a working solution is formed from the combined solutions. The method 400 includes a step 406, wherein a controlled hydrodynamic shear field, a controlled mixing regime, or a combination thereof is generated. The method 400 includes a step 408, wherein magnesium is precipitated from the working solution.

In embodiments, the reaction vessel may include a device adapted to generate controlled hydrodynamic shear or mixing conditions, including but not limited to rotating-cylinder systems, mechanically agitated reactors, static mixers, or oscillatory flow reactors. The shear rate, energy-dissipation rate, or micromixing time may be selected to enhance the precipitation efficiency of magnesium hydroxide relative to passive or diffusion-limited mixing.

In embodiments where the step of combining occurs in a mechanically agitated vessel that includes one or more impellers, the impeller rotational speed may range from about 100 rpm (rotations per minute) to about 2000 rpm. For example, the impeller rotational speed may be about 100 rpm, about 200 rpm, about 300 rpm, about 400 rpm, about 500 rpm, about 600 rpm, about 700 rpm, about 800 rpm, about 1000 rpm, about 1200 rpm, about 1400 rpm, about 1600 rpm, about 1800 rpm, about 2000 rpm, or any value contained within a range formed by any two of the preceding values. The mechanically agitated vessel may further include baffles to suppress bulk vortex formation while enhancing micro-scale turbulent eddies. The resulting hydrodynamic conditions generate shear fields and mixing patterns sufficient to promote rapid nucleation and growth of magnesium hydroxide precipitates. The performance of such mechanically agitated reactors has been experimentally observed to approach that of Taylor-Couette-based implementations when operated within target shear-rate or mixing-intensity windows.

In embodiments, the magnesium produced by the present method can have a purity of greater than or equal to about 50% as measured by mass spectrometry, elemental analysis, or a combination thereof. For example, the magnesium produced by the present method may have a purity of about 50%, about 55%, about 60%, about 65%, about 70%, about 75%, about 80%, about 85%, about 90%, about 95%, about 100%, or any value contained within a range formed by any two of the preceding values.

The purity and quality of the magnesium produced may be further analyzed by X-ray diffraction (XRD). While quantitative XRD may be used to quantify the purity of the produced magnesium, XRD may also be used to qualitatively assess the magnesium. For example, an XRD of the magnesium produced by the present method may be compared to literature XRD diffractograms for magnesium, and the presence of characteristic peaks of magnesium and absence of peaks corresponding to impurities may be indicative that the magnesium is sufficiently pure.

The embodiments disclosed herein may be combined in any manner to form new embodiments.

### EXAMPLES

The following examples were carried out according to embodiments of the present disclosure.

### Example 1—Production of Magnesium

Seawater was pretreated with a Dissolved Air Flotation (DAF) and Sand Filter to remove fine particles and organics to avoid fouling of downstream equipment, which may include Reverse Osmosis (RO). Then the two solutions (seawater and sodium hydroxide) were introduced into the Taylor-Couette reactor. The magnesium hydroxide precipitate formation was governed by the flow regime, reaction kinetics and the shear effects.

Then the collected precipitates were sent to a decanter centrifuge for washing and dewatering. The output of sodium hydroxide solution stream was collected in a Residual NaOH Solution Tank to be used for the cake washing and preparation of sodium hydroxide 0.1 M solution. The pH of the cake was kept at a level about 12.4 to avoid precipitate dissolution and product loss. The pH of a 0.1 M sodium hydroxide solution was about 13, which dropped to 12.4 due to the reduction in hydroxide content which was consumed for magnesium hydroxide precipitation.

The seawater output was collected in a Residual Seawater Tank from where it can be discharged into the sea after a pH measurement. If this solution is not mixed with a 0.1 M sodium hydroxide solution, the pH should remain similar to that of seawater. The residual seawater contained concentrated salts of seawater from which some of the magnesium content was extracted. The magnesium hydroxide suspension was dewatered in a centrifuge decanter to remove the residual mother liquor before sending it to a Magnesium Chloride Reactor. The cake was washed with residual NaOH solution in centrifuge decanter to remove dissolved seawater salts.

The magnesium hydroxide cake was washed efficiently to remove the residual seawater. The remaining seawater salts in the cake can have a negative effect on the quality of final product.

The dewatered magnesium hydroxide was conveyed to the Magnesium Chloride Reactor where it was mixed with HCl 33% and demineralized water to generate a magnesium chloride solution. There system included two Magnesium Chloride Reactors with one hour buffer capacity for each of them. Two or more reactors may be used with a total buffer capacity of at least one hour. The reactors were connected by pipes, and flow moved by gravity from first reactor to the second one. Each reactor can be bypassed if unexpected maintenance or shutdown is required. Alternatively, the process can continue with one reactor.

The magnesium chloride solution was pumped from a feed tank to an evaporator to evaporate excess of water before the crystallization step. The evaporator and crystallizer used steam for heating. The distillates from the evaporator and crystallizer were collected in the distillate tank. The distillate can be used as demineralized water for the plant's internal uses.

The mother liquor from the evaporator flowed to the mother liquor tank from where it was pumped into the crystallizer. The main salt in the mother liquor was magnesium chloride, though the mother liquor also contained residual seawater salts. Magnesium chloride hexahydrate (MgCl₂·6H₂O) was crystallized in the crystallizer and conveyed into a dryer to remove the remaining water, dehydrating the crystals to produce anhydrous magnesium chloride (MgCl₂) crystals. The residual seawater salts were purged from the crystallizer in the form of a waste solution, while the evaporated water was discharged into the distillate tank.

The purged salt solution was collected in the sump from where it can be discharged into the sea after pH measurement. The dried anhydrous magnesium chloride salts were conveyed into an electrolysis system to extract elemental magnesium which is the final product of plant.

Produced magnesium chloride from the upstream processes was stored in intermediate buffer silos. The plant includes a dedicated silo for each electrolysis cell, which are refractory lined vessels including two compartments: an electrolysis compartment and a metal-separating compartment. The compartments are divided by partition wall which allows molten magnesium and electrolyte to flow through. The electrolysis compartment further houses the electrodes: graphite anodes and steel cathodes which are used to conduct electricity into the molten bath. The magnesium chloride was introduced into the electrolysis compartment wherein the magnesium chloride was reduced to elemental magnesium and chlorine gas.

Elemental magnesium was collected into the metal-separation compartment (after passing through the partition) and chlorine gas was discharged from the cell to further processing. If there was an excess amount of other chlorides in the feed, the electrolyte composition was adjusted by adding other salts. Using other salts in the electrolyte helps to keep melting temperature of the bath in the right range. The electrolyte composition was maintained at about 15% MgCl₂, about 40% CaCl₂, about 30% NaCl, and about 15% KCl.

Elemental magnesium was removed from the cell with a vacuum vessel, after which the magnesium is discharged into the holding furnace. The holding furnace acted as buffer between continuous casting operation and batch wise magnesium removal. Molten magnesium from the holding furnace was pumped to the casting machine where oxide dross was removed from the surface of the magnesium. During casting, molten magnesium was solidified into ingots which were then stacked. Stacked and wrapped ingot bundles can be then transported into a storage area to await shipping or other use.

### Example 2—Agitator Mixing Tank Implementation

A mechanically agitated mixing tank equipped with a pitched-blade turbine impeller was used to combine seawater and sodium hydroxide. The impeller speed was adjusted to generate a controlled shear rate comparable to that produced during Taylor vortex flow. Magnesium hydroxide precipitation was observed with high conversion efficiency. The precipitate was then dewatered, washed, and processed according to the methods described in Example 1.

### Example 3—Calcium Hydroxide as the Hydroxide Reagent

Seawater was pretreated as described in Example 1. A slurry of calcium hydroxide (Ca(OH)₂) was prepared by dispersing Ca(OH)₂ powder into demineralized water under agitation to form a pumpable suspension. The slurry was introduced into the Taylor-Couette reactor concurrently with the seawater feed. Under Taylor vortex flow, magnesium hydroxide precipitated from the working solution with measurable conversion efficiency. The hydrodynamic conditions were selected to maintain uniform suspension of the Ca(OH)₂ particles and to promote dispersion and dissolution of hydroxide ions into the seawater. The resulting Mg(OH)₂ precipitate was collected, washed, and dewatered as described in Example 1.

Comparable precipitation behavior was observed in a mechanically agitated mixing-tank reactor (as described in Example 2), where the Ca(OH)₂ slurry was introduced under controlled shear conditions generated by an impeller. The resulting magnesium hydroxide was similarly isolated and processed. This example demonstrates that calcium hydroxide may be used as an alternative hydroxide source across multiple hydrodynamic reactor configurations.

This disclosure is not limited to the particular systems, devices and methods described, as these may vary. The terminology used in the description is for the purpose of describing the particular versions or embodiments only and is not intended to limit the scope.

In the above detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” et cetera). While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups. It will be further understood by those within the art that if a specific number of an introduced claim recitation is intended, such an intent will be explicitly recited in the claim, and in the absence of such recitation no such intent is present.

For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, et cetera” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, et cetera). In those instances where a convention analogous to “at least one of A, B, or C, et cetera” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, et cetera). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, et cetera. As a non-limiting example, each range discussed herein can be readily broken down into a lower third, middle third and upper third, et cetera. As will also be understood by one skilled in the art all language such as “up to,” “at least,” and the like include the number recited and refer to ranges that can be subsequently broken down into subranges as discussed above. Finally, as will be understood by one skilled in the art, a range includes each individual member. Thus, for example, a group having 1-3 compounds refers to groups having 1, 2, or 3 compounds. Similarly, a group having 1-5 compounds refers to groups having 1, 2, 3, 4, or 5 compounds, and so forth.

Various of the above-disclosed and other features and functions, or alternatives thereof, may be combined into many other different systems or applications. Various presently unforeseen or unanticipated alternatives, modifications, variations, or improvements therein may be subsequently made by those skilled in the art, each of which is also intended to be encompassed by the disclosed embodiments.

What is claimed is:

1. A method of producing magnesium, comprising:
combining a magnesium-containing solution and a hydroxide solution in a reaction vessel, the reaction vessel comprising:
an outer cylinder, and
an inner cylinder within the outer cylinder and separated from the outer cylinder by a gap,
wherein the magnesium-containing solution and the hydroxide solution are combined within the gap to form a working solution,
rotating the inner cylinder at a first angular velocity to produce a laminar Couette flow, and
rotating the inner cylinder at a second angular velocity, wherein the second angular velocity is greater than the first angular velocity, to produce a Taylor vortex flow,
thereby precipitating magnesium from the working solution.

2. The method of claim 1, wherein the magnesium-containing solution comprises seawater.

3. The method of claim 1, wherein the hydroxide solution comprises sodium hydroxide, lithium hydroxide, potassium hydroxide, calcium hydroxide, or combinations thereof.

4. The method of claim 1, wherein the hydroxide solution has a concentration of about 0.05 M to about 5 M.

5. The method of claim 1, wherein the first angular velocity and the second angular velocity are defined by:
$$ω = \frac{R {e}_{i} \cdot μ}{ρ \cdot {R}_{i} \cdot d} ;$$
wherein ω is angular velocity, Reᵢ is a Reynolds number of the inner cylinder, Rᵢ is a radius of the inner cylinder, μ is a dynamic viscosity of the working solution, ρ is a density of the working solution, and dis a width of the gap.

6. The method of claim 1, wherein the laminar Couette flow, the Taylor vortex flow, or a combination thereof has a stability characterized by a Taylor number (Tₐ).

7. The method of claim 6, wherein the Taylor number (Tₐ) is defined by:
$${T}_{a} = \frac{ω \cdot {R}_{i} \cdot d}{v} ,$$
wherein ω is angular velocity, Rᵢ is a radius of the inner cylinder, d is a width of the gap, and v is a kinematic viscosity of the working solution.

8. The method of claim 6, wherein the Taylor number of the Taylor vortex flow is greater than the Taylor number of the laminar Couette flow.

9. The method of claim 1, wherein the magnesium has a purity of greater than or equal to about 50% as measured by mass spectrometry, elemental analysis, or a combination thereof.

10. The method of claim 1, wherein the magnesium has a purity of greater than or equal to about 75% as measured by mass spectrometry, elemental analysis, or a combination thereof.

11. The method of claim 1, wherein the magnesium has a purity of greater than or equal to about 95% as measured by mass spectrometry, elemental analysis, or a combination thereof.

12. The method of claim 1, further comprising separating the magnesium.

13. The method of claim 12, wherein separating the magnesium comprises dewatering the magnesium from the working solution.

14. The method of claim 1, further comprising precipitating calcium, lithium, vanadium, or combinations thereof from the working solution.

15. The method of claim 1, further comprising combining additional magnesium-containing solution and additional hydroxide solution to produce magnesium continuously.

16. The method of claim 1, wherein the method does not produce carbon dioxide.

17. The method of claim 1, wherein the magnesium is precipitated from the working solution in the form of magnesium hydroxide.

18. The method of claim 17, further comprising reducing the magnesium hydroxide to magnesium oxide.

19. The method of claim 17, further comprising reducing the magnesium hydroxide to elemental magnesium.

20. The method of claim 19, wherein reducing the magnesium hydroxide to elemental magnesium comprises converting the magnesium hydroxide to magnesium chloride, subjecting the magnesium chloride to electrolysis to produce elemental magnesium, and collecting the elemental magnesium.

21. The method of claim 19, wherein reducing the magnesium hydroxide to elemental magnesium comprises:
dewatering the magnesium hydroxide from the working solution to yield a magnesium hydroxide cake;
combining the magnesium hydroxide cake with aqueous hydrochloric acid to yield a magnesium chloride solution;
drying the magnesium chloride solution to yield magnesium chloride;
subjecting the magnesium chloride to an electrolysis process to yield elemental magnesium; and
collecting the elemental magnesium by vacuum.

22. A method of producing magnesium, comprising:
combining a magnesium-containing solution and a hydroxide solution in a reaction vessel, the reaction vessel comprising:
an outer cylinder, and
an inner cylinder within the outer cylinder and separated from the outer cylinder by a gap,
wherein the magnesium-containing solution and the hydroxide solution are combined within the gap to form a working solution;
rotating the inner cylinder at a first angular velocity to produce a laminar Couette flow;
rotating the inner cylinder at a second angular velocity, wherein the second angular velocity is greater than the first angular velocity, to produce a Taylor vortex flow;
thereby precipitating magnesium hydroxide from the working solution;
dewatering the magnesium hydroxide from the working solution to yield a magnesium hydroxide cake;
combining the magnesium hydroxide cake with aqueous hydrochloric acid to yield a magnesium chloride solution;
drying the magnesium chloride solution to yield solid magnesium chloride;
subjecting the solid magnesium chloride to an electrolysis process to yield elemental magnesium; and
collecting the elemental magnesium.

23. A method of producing magnesium, comprising:
combining a magnesium-containing solution and a hydroxide solution in a reaction vessel,
wherein the magnesium-containing solution and the hydroxide solution are combined to form a working solution,
wherein the reaction vessel generates a controlled hydrodynamic shear field, a controlled mixing regime, or a combination thereof,
thereby precipitating magnesium from the working solution.

24. The method of claim 23, wherein the reaction vessel comprises a Taylor-Couette reactor, a mechanically agitated reactor, a rotating cylinder system, a baffled stirred tank, a static mixer, an oscillatory flow reactor, or a vortex-inducing reactor.

25. The method of claim 23, wherein the reaction vessel comprises one or more impellers.

26. The method of claim 25, comprising rotating the one or more impellers at a rotational speed of about 100 rpm to about 2000 rpm.

27. The method of claim 23, wherein the magnesium-containing solution comprises seawater.

28. The method of claim 23, wherein the hydroxide solution comprises sodium hydroxide, lithium hydroxide, potassium hydroxide, calcium hydroxide, or combinations thereof.

29. The method of claim 23, wherein the hydroxide solution has a concentration of about 0.05 M to about 5 M.

30. The method of claim 23, further comprising separating the magnesium.

31. The method of claim 30, wherein separating the magnesium comprises dewatering the magnesium from the working solution.
